(19) United States
(12) Patent Application Publication
(10) Pub. No.: US 2025/0330035 A1
(43) Pub. Date: Oct. 23, 2025

(54) Human Interface Device Using Super Capacitor

(71) Applicant: Acrox Technologies Co., Ltd., TAIPEI CITY (TW)

(72) Inventors: CHIN-SUNG HO, TAIPEI CITY (TW); AN-HSI WANG, TAIPEI CITY (TW)

(21) Appl. No.: 18/955,393

(22) Filed: Nov. 21, 2024

(30) Foreign Application Priority Data
Apr. 17, 2024 (TW) 113114345

(51) Int. Cl. H02J 7/00; H02J 7/34

(52) U.S. Cl. CPC H02J 7/007182; H02J 7/00034; H02J 7/00302; H02J 7/0047; H02J 7/345; H02J 2207/20; H02J 2207/50

(57) ABSTRACT

The present disclosure provides a human interface device (HID) that uses a super capacitor. The human interface device mainly includes a power circuit and a main control module. The power circuit includes a control unit and a rapid charging unit, and can be detachably connected to an external DC power supply. The control unit is configured to determine whether to charge the super capacitor. The rapid charging unit is electrically connected to the control unit and is configured to immediately provide a constant charging current to the super capacitor upon receiving a charging signal from the control unit. The main control module is electrically connected to the power circuit and the super capacitor, and is configured to monitor a capacitor voltage of the super capacitor and determine whether to continue charging the super capacitor.

### CROSS-REFERENCE TO RELATED APPLICATION AND CLAIM OF PRIORITY

The application claims the benefit of Taiwan Patent Application No. 113114345, filed on Apr. 17, 2024, at the Taiwan Intellectual Property Office, the disclosures of which are incorporated herein in their entirety by reference.

### FIELD OF THE INVENTION

The present disclosure generally relates to a human interface device and, more particularly, to a human interface device using a super capacitor instead of the conventional lithium battery. The human interface device of the present disclosure can avoid the environmental pollution issues associated with lithium batteries, and can enhance charging efficiency to save valuable time by using the super capacitor.

### BACKGROUND OF THE INVENTION

With the rapid development of digital technology, human interface devices such as wireless keyboards, mice, and drawing tablets have become indispensable parts of our daily lives and work. These devices often rely on built-in batteries that provide the necessary power. For a long time, lithium batteries have been widely used due to their relatively high energy density and long lifespan. However, with increasing demands for environmental protection and energy efficiency, conventional human interface devices that use lithium batteries have the following disadvantages:

Firstly, the lithium batteries may have a significant environmental impact during production, use, and disposal. They contain harmful substances, such as lithium, cobalt, and nickel, which pollute soil and water sources. Moreover, due to improper disposal of discarded lithium batteries, these harmful substances will be released into the environment to cause long-term environmental issues.

Secondly, compared to super capacitors, the lithium batteries have a relatively long charging time, which is inconvenient for human interface devices that require quick charging and frequent use. Additionally, the charge and discharge cycles of the lithium batteries are limited, and their ability to store energy is gradually decreased over time, shortening the lifespan of the device.

Furthermore, the lithium batteries pose risks of overheating, fire, and even explosion, especially in cases of overcharging or physical damage. These safety issues not only pose a direct threat to users but also present significant legal and financial risks to manufacturers. The performance of the lithium batteries significantly declines under extreme temperature conditions. In low-temperature environments, the energy release capacity of the lithium batteries is greatly reduced, while in high-temperature conditions, the chemical stability of the lithium batteries is decreased, and both will increase safety risks.

Therefore, there is a need to provide a human interface device that uses a super capacitor, which not only avoids the drawbacks associated with the lithium batteries, but also improves charging efficiency and saves valuable time.

### SUMMARY OF THE INVENTION

One of the objectives of the present disclosure is to provide a human interface device that uses a super capacitor instead of the conventional lithium battery. The human interface device of the present disclosure can avoid the environmental pollution issues associated with lithium batteries, and can enhance charging efficiency to save valuable time by using the super capacitor.

To achieve the above objective, in one aspect, the present disclosure provides a human interface device (HID) that uses a super capacitor. The human interface device mainly includes a power circuit and a main control module. The power circuit includes a control unit and a rapid charging unit, and can be detachably connected to an external DC power supply. The control unit is configured to determine whether to charge the super capacitor. The rapid charging unit is electrically connected to the control unit and is configured to immediately provide a constant charging current to the super capacitor upon receiving a charging signal from the control unit. The main control module is electrically connected to the power circuit and the super capacitor, and is configured to monitor a capacitor voltage of the super capacitor and determine whether to continue charging the super capacitor.

In another aspect, the present disclosure further provides a human interface device (HID) that uses a super capacitor. The human interface device mainly includes a power circuit. The power circuit is detachably connected to an external DC power supply and is configured to determine whether to immediately provide a constant charging current to charge the super capacitor. The power circuit includes a control unit and a rapid charging unit. The control unit is configured to determine whether to charge the super capacitor. The rapid charging unit is electrically connected to the control unit, and is configured to provide a constant charging current to the super capacitor immediately upon receiving a charging signal issued by the control unit.

In another aspect, the present disclosure further provides a method for charging a super capacitor used in a human interface device. The method includes the following steps. First, an external DC power supply is detachably connected to a power circuit, allowing the power circuit to determine whether to immediately provide a constant charging current to charge the super capacitor. Then, the main control module monitors the super capacitor and determines whether to continue charging the super capacitor.

In summary, in the human interface device of the present disclosure, the conventional lithium battery is replaced with the super capacitor. This avoids the pollution issues associated with lithium batteries and enhances charging efficiency to save time.

### BRIEF DESCRIPTION OF THE DRAWINGS

The above objectives and advantages of the present disclosure will become more apparent to those skilled in the art after reviewing the following detailed description with accompanying drawings.

FIG. 1 is a schematic circuit diagram of a human interface device using a super capacitor according to one embodiment of the present disclosure.

FIG. 2 is a schematic circuit diagram of a power circuit of a human interface device using a super capacitor according to one embodiment of the present disclosure.

FIG. 3 is a flowchart of a method for charging a super capacitor used in a human interface device according to one embodiment of the present disclosure.

FIG. 4 is a flowchart of steps for determining whether to immediately provide a constant charging current to charge the super capacitor as shown in FIG. 3 of the present disclosure.

### DETAILED DESCRIPTION OF THE PREFERRED EMBODIMENTS

Please refer to all figures of the present disclosure when reading the following detailed description, wherein all figures of the present disclosure demonstrate different embodiments of the present disclosure by showing examples, and help the skilled person in the art to understand how to implement the present disclosure. The present examples provide sufficient embodiments to demonstrate the spirit of the present disclosure, each embodiment does not conflict with the others, and new embodiments can be implemented through an arbitrary combination thereof, i.e., the present disclosure is not restricted to the embodiments disclosed in the present specification. Unless there are other restrictions defined in the specific example, the following definitions apply to the terms used throughout the specification.

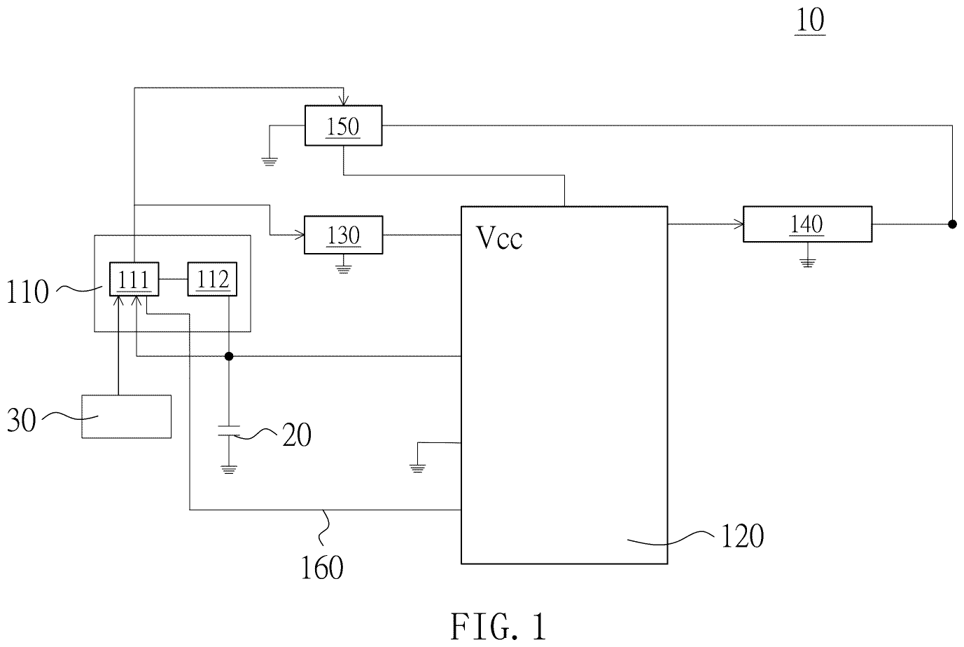

Please refer to FIG. 1, which is a schematic circuit diagram of a human interface device using a super capacitor according to one embodiment of the present disclosure. In FIG. 1, the human interface device 10 of the present disclosure is mainly powered by a super capacitor 20. The human interface device 10 can be an interface device such as a keyboard, a mouse, a trackball, a touchpad, a pointing stick, a light pen, a graphics tablet, or a game controller that allows the user to input data into a computer. In one embodiment, the human interface device 10 primarily includes a power circuit 110 and a main control module 120. The power circuit 110 is detachably connected to an external DC power supply 30 and is configured to determine whether to immediately provide a constant charging current to charge the super capacitor 20. The main control module 120 is electrically connected to the power circuit 110 and the super capacitor 20, and is configured to monitor a capacitor voltage of the super capacitor 20 and determine whether to continue charging the super capacitor 20. In one embodiment, the power circuit 110 includes a control unit 111 and a rapid charging unit 112. The control unit 111 is detachably connected to the external DC power supply 30 and is configured to receive a charging enable/disable signal from the main control module 120 to determine whether to charge the super capacitor 20. The rapid charging unit 112 is electrically connected to the control unit 111 and is configured to immediately provide the constant charging current to the super capacitor 20 upon receiving a charging signal from the control unit 111.

In practical applications, for example, when the rapid charging unit 112 receives the charging signal from the control unit 111 indicating that charging can proceed, the rapid charging unit 112 will activate the rapid charging mechanism. When the rapid charging unit 112 begins rapid charging, whether the temperature, current, and voltage exceed preset values will be first determined. If the temperature, current and voltage are below the preset ranges, the rapid charging unit 112 will immediately begin charging with the constant charging current.

In one embodiment, the control unit 111 is configured to further determine that the human interface device 10 is powered by the external DC power supply 30 or the super capacitor 20. In one embodiment, the human interface device 10 also includes a voltage regulator 130 electrically connected to the power circuit 110 and the main control module 120. When the power circuit 110 is connected to the external DC power supply 30, the voltage regulator 130 regulates a first power supplied by the external DC power supply 30 at a first power voltage and transmits it to the main control module 120 as the system DC power of the main control module 120. When the power circuit 110 is disconnected from the external DC power supply 30, the voltage regulator 130 regulates a second power supplied by the super capacitor 20 at the first power voltage and transmits it to the main control module 120. In one embodiment, for example, the first power voltage can be around 2.2V.

In practical applications, for example, if the super capacitor 20 or external DC power supply 30 can provide stable power, the power circuit 110 will output power at a voltage ranging between 2.5V and 3.8V for use by the human interface device 10. Conversely, if the super capacitor 20 or external DC power supply 30 fails to supply sufficient power (e.g., when the capacitor voltage of the super capacitor 20 is below 2.5V), the power circuit 110 will send a power-off signal to the human interface device 10, and the human interface device 10 will shut off all power and enter a standby mode to protect the super capacitor 20 from reducing lifespan due to over-discharge.

In one embodiment, the human interface device 10 further includes a buck-boost circuit 150 and a display indicator 140. The buck-boost circuit 150 is electrically connected to the power circuit 110 and the main control module 120. Upon receiving an enable signal from the main control module 120, the buck-boost circuit 150 regulates the first power or the second power supplied by the power circuit 110 (e.g., between 2.5V and 3.8V) at a second power voltage and transmits a third power to the display indicator 140. Upon receiving a disable signal from the main control module 120, the buck-boost circuit 150 stops functioning. In one embodiment, the second power voltage can be around 3.3V. In one embodiment, the display indicator 140 can be used to alert the user when the power is turned on, when Bluetooth is pairing, when the second power supplied by the super capacitor 20 is insufficient, or when the input is in uppercase mode.

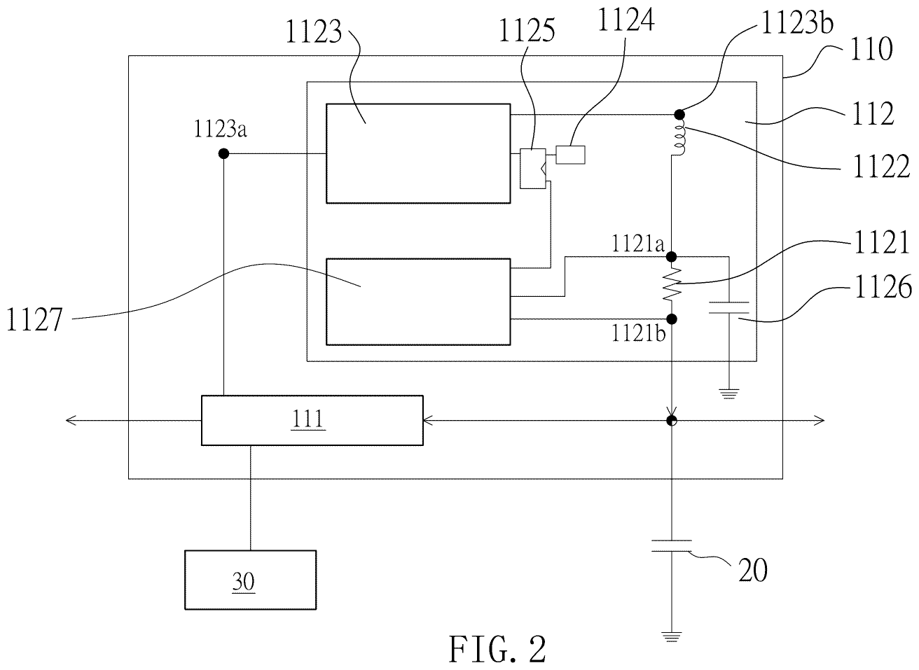

FIG. 2 is a schematic circuit diagram of a power circuit of a human interface device using a super capacitor according to one embodiment of the present disclosure. In FIG. 2, the power circuit 110 includes a control unit 111 and a rapid charging unit 112. The rapid charging unit 112 includes a reference resistor 1121, a boost inductor 1122, a boost switching circuit 1123, an oscillator 1124, a flip-flop 1125, a storage capacitor 1126, and a detection circuit 1127. The boost inductor 1122 has one end electrically connected to the reference resistor 1121, and is configured to determine a charging voltage across two ends 1121a and 1121b of the reference resistor 1121. The boost switching circuit 1123 is configured to receive a control signal from the control unit 111 at a signal input end 1123a and output a boost signal to the boost inductor 1122 at a signal output end 1123b. The oscillator 1124 is electrically connected to the boost switching circuit 1123 through the flip-flop 1125 and is configured to provide a boost cycle signal to control the boost signal of the boost switching circuit 1123. The flip-flop 1125 is configured to determine whether to transmit the boost cycle signal to the boost switching circuit 1123. The detection circuit 1127 is electrically connected to the two ends 1121a and 1121b of the reference resistor 1121, and is configured to turn on the flip-flop 1125 when the charging voltage does not reach a preset value, or turn off the flip-flop 1125 when the charging voltage reaches the preset value.

In one embodiment, the reference resistor 1121 is configured to determine a current value of the constant charging current. In other words, the constant charging current can be changed by changing the resistance value of the reference resistor 1121. For example, in one embodiment, the current value of the constant charging current can be set at around 25C. In actual operations, once the current value of the constant charging current is set, the oscillator 1124 will be activated and provide the boost cycle signal, allowing the boost switching circuit 1123 to introduce an input voltage at the signal input end 1123a, and enabling the boost inductor 1122 and the storage capacitor 1126 connected to the signal output end 1123b to facilitate in the boosting operation. The charging current of the super capacitor 20 is the current flowing through the reference resistor 1121, i.e., the charging voltage difference between the two ends 1121a and 1121b of the reference resistor 1121 divided by the resistance value R of the reference resistor 1121. In one embodiment, the frequency of the boost cycle signal provided by the oscillator 1124 is between 600 kHz and 900 kHz.

When the charging current from the rapid charging unit 112 to the super capacitor 20 is below the preset value, the boost switching circuit 1123 will continue boosting to increase the current. When the charging current of the rapid charging unit 112 exceeds the preset value, the boost switching circuit 1123 will stop functioning, so that the charging current is reduced to not exceeding the preset value. This feedback loop will continue to operate until the super capacitor 20 is fully charged.

During the charging process, the main control module 120 continuously monitors the voltage of the super capacitor 20. When the voltage at the end 1121a reaches the maximum voltage of the super capacitor 20, the main control module 120 sends the disable signal through a transmission line 160 in FIG. 1 to notify the rapid charging unit 112 in the power circuit 110 to stop functioning.

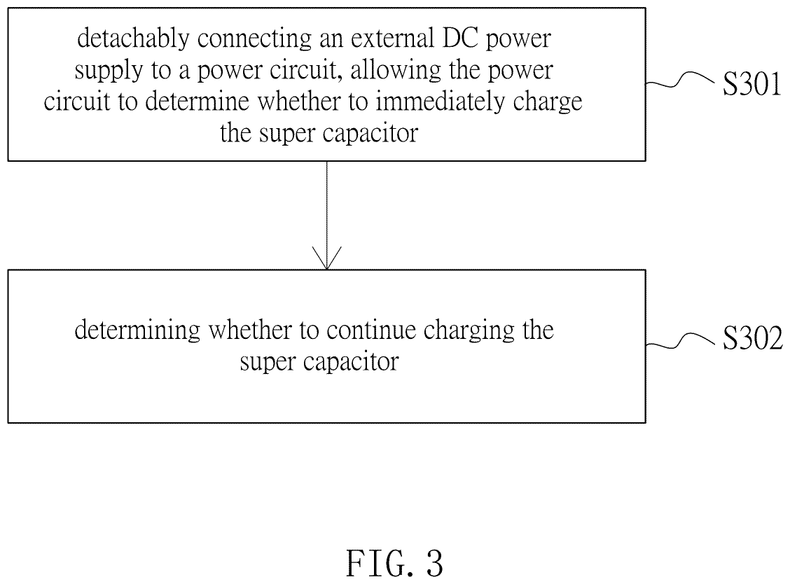

Thus, with reference to the circuit diagrams of the power circuit of the human interface device using the super capacitor shown in FIG. 1 and FIG. 2, the present disclosure provides a method for charging the super capacitor used in the human interface device, including the following steps as shown in the flowchart in FIG. 3. First, in step S301, an external DC power supply 30 is detachably connected to the power circuit 110, allowing the power circuit 110 to determine whether to immediately provide a constant charging current to charge the super capacitor 20. Next, in step S302, the main control module 120 monitors a capacitor voltage of the super capacitor 20 and determines whether to continue charging the super capacitor 20.

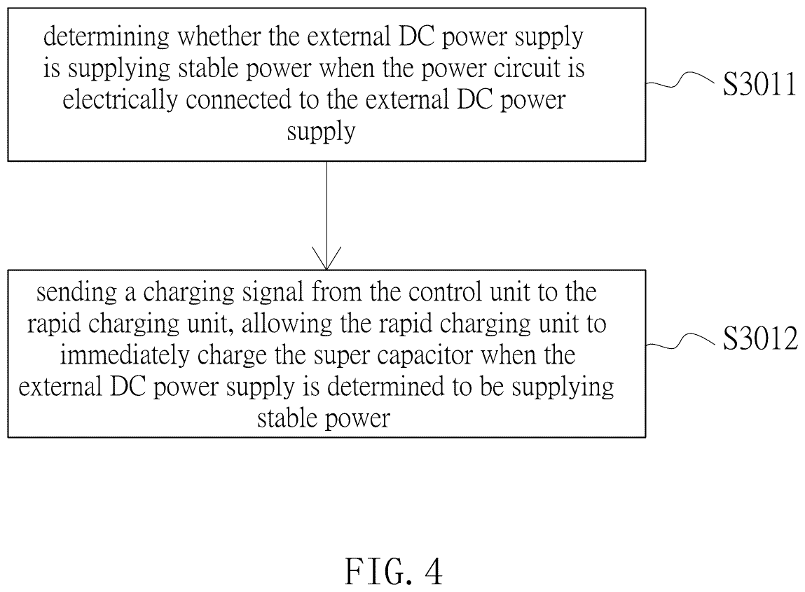

More particularly, the step of determining whether to immediately provide the constant charging current to charge the super capacitor 20 in step S301 includes the following steps as shown in the flowchart of FIG. 4. In step S3011, when the power circuit 110 is electrically connected to the external DC power supply 30, it is determined whether the external DC power supply 30 is supplying stable power. Next, in step S3012, when the external DC power supply 30 is determined to be supplying stable power, the control unit 111 sends a charging signal to the rapid charging unit 112, causing the rapid charging unit 112 to immediately provide a constant charging current to the super capacitor 20.

In the present disclosure, the super capacitor is used to replace conventional chemical batteries, such as lithium batteries, as the power source for the human interface device. Unlike conventional chemical batteries, which require a trickle charge circuit design during charging, the present disclosure uses a super capacitor as the power source for the human interface device, enabling a rapid charging function with a charging speed 25 times faster than the traditional charging circuits. As a result, it only takes three minutes of rapid charging to go from 0% to 100%, allowing the human interface device to be used for over two months.

As discussed above, it can be seen that the human interface device using a super capacitor as disclosed in this application can replace conventional lithium batteries with a super capacitor, thereby avoiding the pollution problems associated with lithium batteries while also improving charging efficiency and saving valuable time through the use of a super capacitor.

Although the present disclosure has been disclosed above through several embodiments or examples, it is not intended to limit the disclosure. Any person skilled in the art may make minor changes and modifications without departing from the spirit and scope of the disclosure, and therefore, the scope of the present disclosure should be determined by the appended claims.

What is claimed is:

1. A human interface device using a super capacitor, comprising:
a power circuit detachably connected to an external DC power supply, and including:
a control unit configured to determine whether to charge the super capacitor; and
a rapid charging unit electrically connected to the control unit and configured to provide a constant charging current to the super capacitor immediately upon receiving a charging signal issued by the control unit; and
a main control module electrically connected to the power circuit and the super capacitor and configured to determine whether to continue charging the super capacitor.

2. The human interface device as claimed in claim 1, wherein the control unit is further configured to determine whether the human interface device is powered by the external DC power supply or the super capacitor.

3. The human interface device as claimed in claim 1, wherein the main control module is further configured to monitor a capacitor voltage of the super capacitor.

4. The human interface device as claimed in claim 1, further comprising:
a voltage regulator electrically connected to the power circuit and the main control module, and configured to:
regulate a first power supplied by the external DC power supply at a first power voltage and transmit the first power to the main control module when the power circuit is connected to the external DC power supply; or
regulate a second power supplied by the super capacitor at the first power voltage and transmit the second power to the main control module when the power circuit is disconnected from the external DC power supply.

5. The human interface device as claimed in claim 4, further comprising:
a display indicator; and
a buck-boost circuit configured to provide a third power to the display indicator, wherein the buck-boost circuit is electrically connected to the power circuit and the main control module and is configured to:
regulate the first power or the second power supplied by the power circuit at a second power voltage and transmit the first power or the second power to the display indicator upon receiving an enable signal from the main control module; or
cease operations upon receiving a disable signal from the main control module.

6. The human interface device as claimed in claim 1, wherein the rapid charging unit comprises:
a reference resistor configured to determine a current value of the constant charging current;
a boost inductor having one end electrically connected to the reference resistor, and configured to determine a charging voltage across two ends of the reference resistor;
a boost switching circuit configured to receive a control signal from the control unit at a signal input end and output a boost signal to the boost inductor at a signal output end;
an oscillator electrically connected to the boost switching circuit through a flip-flop, and configured to provide a boost cycle signal to control the boost signal of the boost switching circuit, wherein the flip-flop is configured to determine whether to transmit the boost cycle signal to the boost switching circuit; and
a detection circuit electrically connected to the two ends of the reference resistor, and configured to turn on the flip-flop when the charging voltage is below a preset value, or turn off the flip-flop when the charging voltage reaches the preset value.

7. A human interface device using a super capacitor, comprising:
a power circuit detachably connected to an external DC power supply, and including:
a control unit configured to determine whether to charge the super capacitor; and
a rapid charging unit electrically connected to the control unit, and configured to provide a constant charging current to the super capacitor immediately upon receiving a charging signal issued by the control unit.

8. The human interface device of claim 7, wherein the control unit is further configured to determine whether the human interface device is powered by the external DC power supply or the super capacitor.

9. The human interface device as claimed in claim 7, wherein the rapid charging unit comprises:
a reference resistor configured to determine a current value of the constant charging current;
a boost inductor having one end electrically connected to the reference resistor, and configured to determine a charging voltage across two ends of the reference resistor;
a boost switching circuit configured to receive a control signal from the control unit at a signal input end, and output a boost signal to the boost inductor at a signal output end;
an oscillator electrically connected to the boost switching circuit through a flip-flop, and configured to provide a boost cycle signal to control the boost signal of the boost switching circuit, wherein the flip-flop is configured to determine whether to transmit the boost cycle signal to the boost switching circuit; and
a detection circuit electrically connected to the two ends of the reference resistor, and configured to turn on the flip-flop when the charging voltage is below a preset value, or turn off the flip-flop when the charging voltage reaches the preset value.

10. The human interface device as claimed in claim 7, further comprising:
a main control module electrically connected to the power circuit and the super capacitor, and configured to monitor a capacitor voltage of the super capacitor and determine whether to continue charging the super capacitor;
a voltage regulator electrically connected to the power circuit and the main control module, and configured to:
regulate a first power supplied by the external DC power supply at a first power voltage and transmit the first power to the main control module when the power circuit is connected to the external DC power supply; or
regulate a second power supplied by the super capacitor at the first power voltage and transmit the second power to the main control module when the power circuit is disconnected from the external DC power supply.

11. The human interface device as claimed in claim 10, further comprising:
a display indicator; and
a buck-boost circuit configured to provide a third power to the display indicator, wherein the buck-boost circuit is electrically connected to the power circuit and the main control module and is configured to:
regulate the first power or the second power supplied by the power circuit at a second power voltage and transmit the first power or the second power to the display indicator upon receiving an enable signal from the main control module; or
cease operations upon receiving a disable signal from the main control module.

12. A method for charging a super capacitor used in a human interface device, comprising the steps of:
detachably connecting an external DC power supply to a power circuit, allowing the power circuit to determine whether to immediately provide a constant charging current to charge the super capacitor; and
determining whether to continue charging the super capacitor.

13. The method as claimed in claim 12, wherein the power circuit comprises a control unit and a rapid charging unit, and the step of determining whether to immediately provide the constant charging current to charge the super capacitor comprises:
determining whether the external DC power supply is supplying stable power when the power circuit is electrically connected to the external DC power supply; and
sending a charging signal from the control unit to the rapid charging unit, allowing the rapid charging unit to immediately provide the constant charging current to the super capacitor when the external DC power supply is determined to be supplying stable power.

14. The method as claimed in claim 12, further comprising steps of:
monitoring a capacitor voltage of the super capacitor; and
determining whether the capacitor voltage is below a preset value.

15. The method as claimed in claim 14, further comprising a step of:
continuing charging the super capacitor when the capacitor voltage is determined below the preset value.

16. The method as claimed in claim 15, wherein the power circuit comprises a control unit and a rapid charging unit, and the step of determining whether to immediately provide the constant charging current to charge the super capacitor comprises:
determining whether the external DC power supply is supplying a stable power when the power circuit is electrically connected to the external DC power supply; and
sending a charging signal from the control unit to the rapid charging unit, allowing the rapid charging unit to immediately provide the constant charging current to the super capacitor when the external DC power supply is determined to be supplying stable power.

17. The method as claimed in claim 14, further comprising a step of:
stopping charging the super capacitor when the capacitor voltage is determined to have reached the preset value.
